(19) United States
(12) Patent Application Publication
(10) Pub. No.: US 2003/0200305 A1
(43) Pub. Date: Oct. 23, 2003

(54) System and method for collecting metrics from a remote computer system

(76) Inventors: Linda Spilo Tarby, Sunnyvale, CA (US); Ken Deh-Lee, Union City, CA (US)

Correspondence Address: HEWLETT-PACKARD COMPANY, Intellectual Property Administration, P.O. Box 272400, Fort Collins, CO, 80527-2400, US

(21) Appl. No.: 10/128,405

(22) Filed: Apr. 23, 2002

(51) Int. Cl. G06F 15/173; G06F 15/16

(52) U.S. Cl. 709/224; 709/223; 709/217

(57) ABSTRACT

In one embodiment, the present invention is directed to a system for collecting metrics from at least one remote computer system. The system may comprise: a publish module that is operable to receive a subscription request from the at least one remote computer system and is operable to communicate an executable file to the at least one remote computer system, wherein the executable file is operable to collect the metrics from the at least one remote computer system when the executable file is executed on the at least one remote computer system. The system may also comprise a metrics receiving process that is operable to receive collected metrics from the at least one remote computer system when the at least one remote computer system executes the executable file.

### TECHNICAL FIELD

The present invention is directed to a system and method for collecting metrics from a remote computer system.

### BACKGROUND OF THE INVENTION

Various products have been developed that allow information related to the use of a computer system to be sent to a server application in an autonomous manner. For example, the product “NETCARD” collects information from a configuration file. The configuration file is established by a user application and the application updates the configuration file with information regarding the amount of use of the application by the user on the respective computer system. The “NETCARD” product forwards the information to a server to permit “per-use” accounting for customers who utilize the user application. However, the NETCARD product is problematic for several reasons, a single predefined set of information is collected and forwarded to the server. Accordingly, the collected information cannot be changed after the user application is installed on the customer's computer system.

### BRIEF SUMMARY OF THE INVENTION

In one embodiment, the present invention is directed to a system for collecting metrics from at least one remote computer system. The system may comprise: a publish module that is operable to receive a subscription request from the at least one remote computer system and is operable to communicate an executable file to the at least one remote computer system, wherein the executable file is operable to collect the metrics from the at least one remote computer system when the executable file is executed on the at least one remote computer system. The system may also comprise a metrics receiving process that is operable to receive collected metrics from the at least one remote computer system when the at least one remote computer system executes the executable file.

### BRIEF DESCRIPTION OF THE DRAWINGS

FIG. 1 is a system for collecting metrics according to embodiments of the present invention.

FIG. 2 depicts a computer system that may implement embodiments of the present invention.

FIG. 3 depicts a flowchart associated with distribution and execution of a metrics gathering executable file according to embodiments of the present invention.

FIG. 4 depicts a subscription packet according to embodiments of the present invention.

### DETAILED DESCRIPTION OF THE INVENTION

The present invention is directed to systems and methods for collecting information pertaining to use of computer systems. In embodiments, a subscribe and publish algorithm is employed to distribute an executable file or executable files to client computer systems. The subscription and publish algorithm is preferably initiated automatically by client computer systems. Additionally, the executable file or files preferably define the processing steps related to retrieval of the desired metric information. The processing steps are preferably operable to select a minimal amount of information that is considered relevant for the information requested. The executable files may be automatically executed by the client computer systems via user initiation of a user application or via a boot-up script. The executable file or files preferably collect the information and forward the information to the server application depending on a timing criteria configured for the executable files. The server application may store the received information in a central database for future analysis.

By utilizing a subscribe and publish algorithm, embodiments of the present invention provide several advantages. For example, embodiments of the present invention are not required to collect each and every data element in a registry database or other metrics source. Instead, embodiments of the present invention may limit the collected information to information selected by application developers, customer engineers, or the like. Accordingly, embodiments of the present invention cause little (if any) effect on the performance of client computer systems. Additionally, if the application developers or customer engineers later determine that additional or different information is needed, the collection algorithm may be modified without appreciable difficulty. Moreover, embodiments of the present invention enable uniformity of the collection algorithm across numerous, unrelated client computers. Therefore, analysis of the collected information is not complicated by receiving disparate information from different client computers.

FIG. 1 depicts exemplary system 100 for collecting metrics according to embodiments of the present invention. System 100 comprises server system 101 and client system 102. Server system 101 may be implemented as, for example, a suitable web server platform. According to embodiments of the present invention, server system 101 is operable to retain executable files that perform the collection and forwarding functionality of the metrics gathering process.

The executable files are preferably distributed to client system 102 by communication between publish module 103 and subscription module 113. Publish module 103 is operable to distribute executable files (e.g., collection executable 104A and reset executable 109A) to client system 102. Specifically, subscription module 113 may periodically poll publish module 103 to determine whether any modifications to any executable file has occurred. For example, subscription module 113 may communicate the current versions of its executable files (e.g., collection executable 104A and reset executable 109A) to publish module 103. If the communicated version information does not match the current versions on server system 101, publish module 103 may communicate the modified executable file to subscription module 113.

To illustrate the metrics gathering process, assume that client system 102 is initially installed on a target system at a user location. Client system 102 subscribes to publish module 103. The subscription may occur via any number of mechanisms. For example, subscription module 113 may communicate a suitable subscription request packet via the Internet to publish module 103 of server system 101. In response, publish module 103 may add client system 102 to its subscription list 110.

Since client system 102, in this example, was not previously subscribed, publish module 103 distributes executable files (e.g., collection executable 104A and reset executable 109B) to client system 102. The executable files are stored as copies on client system 102 as collection executable 104B and reset executable 109B. Initialization of selected metrics may occur by execution of reset executable 109B as client system was not previously subscribed. Several techniques may be utilized to invoke collection executable 104B. Collection executable 104B may be invoked automatically during execution of one of user applications 105. Alternatively, the boot-script may be modified by subscription module 113 when executable files are installed on system 102 to cause the automatic execution of collection executable 104B on boot or reset of client system 102. The determination of whether the collection process should be initiated may depend on various criteria. For example, the collection process may be initiated on the basis of various timers (e.g., once per week, month, and/or the like). Additionally or alternatively, the collection process may be initiated on the basis of a predefined event (e.g., installation of an application and/or peripheral).

Collection executable 104B initiates the collection process by retrieving the stored metrics from system registry database 106. As is known in the art, various operating systems provide the capacity to generate information or metrics related to the use of computer systems executing the respective operating systems. For example, MICROSOFT operating systems provide a registry database. The registry database is a central collection of configuration data. The registry database is organized in a hierarchical or tree structure by “keys.” The keys are the individual nodes on the database tree structure. Additionally, a “hive” refers to each data element of the database tree structure below a given key. The configuration data includes a large variety of information. For example, the configuration data includes file association information, user preferences, and current user information. Additionally, the registry database includes settings for system hardware, the operating system, and installed applications. Moreover, the registry database stores performance data related to operating system and application tasks.

As will be discussed in greater detail below, the metrics may include any pertinent system or user data stored or otherwise available on client system 102. For example, user application(s) 105 may store user and performance information in system registry database 106. Additionally or alternatively, operating system 111 may store user, performance, and configuration information in system registry database 106. The present invention is not limited to collection of information from system registry database 106. In addition to system registry database 106, metrics information may alternatively or additionally stored in and retrieved from any suitable storage area that is programmatically accessible. For example, user, performance, and/or configuration data may be retrieved from any suitable storage location or derived by system calls on client system 102.

It shall be appreciated that collection executable 104B is not required to retrieve each and every data element associated with system registry database 106. Instead, collection executable 104B may comprise code that only retrieves predefined or selected data elements. Collection executable 104B may preferably minimize the amount of data to be communicated to server system 101. Accordingly, the publisher of collection executable 104B may minimize the effect of the collection process on a communication network (not shown) associated with client system 102 by controlling the executable instructions of collection executable 104B. Moreover, it shall be appreciated that the personnel publishing collection executable 104B are enabled to ensure that the same collection process is performed at each client system.

Collection executable 104B preferably communicates the retrieved metrics to metrics hook 107. Metrics hook 107 may be implemented as any suitable software process or daemon executed on server system 101. Metrics hook 107 is preferably operable to parse the received metrics before placement of the metrics into metrics database 108.

After the metrics have been stored in metrics database 108, metrics hook 107 may communicate an appropriate signal or packet to acknowledge the receipt of the information. Reset executable 109B may be distributed concurrently with the acknowledgement and automatically executed thereby causing the respective parameters to be reset. Alternatively, user application 105 may reset the parameters by executing reset executable 109B based on a given trigger such as the date. In this case, reset executable 109B may be distributed at the same time that collection executable 104B is distributed. The selection of how reset executable 109B is delivered and invoked would depend on whether the collection process should be initiated by a predictable trigger or invoked in a tunable manner from server system 101.

When application developers decide that it would be appropriate to collect additional and/or different metrics, the application developers may develop new code to modify collection executable 104A. Subscription module 113 may, from time to time, poll publish model 103 to determine whether its executable files (e.g., collection executable 104B and reset executable 109B) are current. If an update or modification has occurred, subscription module 113 sends an appropriate subscription request packet to publish module 103. In response to the subscription request packet, publish module 103 then distributes the modified collection executable 104A to client system 102. Accordingly, the next time a collection process is initiated, the additional and/or different metrics are collected according to the modified code of collection executable 104B.

In alternative embodiments, server system 101 may attempt to communicate the modified executable files without receiving a request from subscription module 113. When a modification to an executable file occurs, server system 101 may access subscription list 110 to identify subscribed platforms. Server system 101 may then automatically distribute the modified executable file to each subscribed platform (including client system 102) via publish module 103.

As previously noted, the WINDOWS registry database stores a large amount of configuration data for a computer system. Collection executable 104B in embodiments of the present invention may collect any suitable information from the WINDOWS registry of client system 102 if client system 102 utilizes a WINDOWS operating system. For example, the WINDOWS registry “HKEY_CURRENT_USER” hive stores various user preference metrics. Additionally, the “HKEY_LOCAL_MACHINE” hive comprises settings for hardware, operating system, and installed applications. Collection executable 104B may collect metrics from these hives. For example, collection executable 104B may determine the hardware resources (peripherals, memory, processor, and/or the like) associated with client system 102 and the respective configuration settings associated with the hardware resources. By determining how client systems are configured, application developers may optimize user applications 105 for the most popular hardware resources and the most common configuration settings. In addition to information regarding system configuration, metrics may be gathered that reflect the hardware parameters associated with client system 102. Pertinent metrics may include processor speed, disk space, amount of random access memory, and/or the like.

The WINDOWS registry database may be accessed by an application programming interface (API). The API may be utilized to retrieve a specific metric by sending an appropriate query to WINDOWS registry database. Moreover, user applications 105 may create performance objects, in part, by utilizing a “CreateRegistryKey” command via the API. Accordingly, user applications 105 may store performance data related to their execution in the WINDOWS registry, if desired. For example, embodiments of the present invention may collect metrics that measure the number of times that one of user applications 105 has been executed by a user; the number of times that a help resource has been accessed; the number of times that a “find” operation was executed; the number of times that a service request was generated, the number of times that a particular document was accessed; and/or the like.

System registry database 106 is depicted in FIG. 1 as a single logical element. However, implementations of system 100 may access multiple files, tables, arrays, databases, and/or the like to obtain the selected metrics. For example, embodiments of the present invention may be implemented on computer systems that utilize WINDOWS operating systems. Collection executable 104B may retrieve metrics from the WINDOWS registry. Additionally, user applications 105 may define or utilize separate files to maintain metrics associated with their performance. Accordingly, collection executable 104B may gather metrics from both the WINDOWS registry and the separate files utilized by user applications 105.

It shall be appreciated that embodiments of the present invention employ the configuration and processing depicted in FIG. 1 utilizing numerous client systems 102. Specifically, embodiments of the present invention collect information from a relatively large population of computer systems to gain an accurate sample of user behavior. By sampling a sufficient population size, embodiments of the present invention allow optimization and further development of user applications 105 to adapt to actual use and operating environments.

After metrics are received from a sufficient population size and stored in metrics database 108, various reports may be generated to analyze usage characteristics. For example, embodiments of the present invention may employ report generator 112 to report the total number of users per region; percentage of active users of one or several of user applications 105; average number of days that one or several of user applications 105 are used; the number of particular documents accessed; the number of users per operating system type; the number of users per hardware type; and/or the like.

As previously discussed, collection executable 104A is preferably provided to client system 102 and periodically updated by utilizing a subscribe and publish algorithm. Embodiments of the present invention may be implemented utilizing a proprietary subscribe and publish algorithm. For example, persons of ordinary skill in the art may create code to develop a daemon process to implement publish module 103. The server daemon process may be associated with a particular Internet Protocol (IP) address and port to communicate messages according to the subscription and publish algorithm. The server deamon process may listen for incoming messages on the port of the IP address. The incoming messages may be requests to determine if updated executable files are available or requests to obtain the updated executable files.

Additionally, the incoming messages may be requests to initiate the subscribe and publish algorithm. The server daemon process may require various handshake messages from subscription module 113 to authenticate client system 102 before allowing client system 102 to subscribe. For example, subscription module 113 may be required to communicate an expected encrypted response according to a challenge/response authentication algorithm.

After validating that client system 102 should be allowed to receive the published executable files, publish module 103 may communicate the executable files to subscription module 113 to place the files on client system 102. The communication of the executable files may occur utilizing any number of suitable communication protocols including, but not limited to, Hypertext Transfer Protocol (HTTP), Uniform Datagram Protocol (UDP), Transfer Control Protocol/Internet Protocol (TCP/IP), and/or the like. After receiving the executable files, subscription interface process may write the executable files to an appropriate non-volatile storage medium (e.g., a hard disk drive).

The first time that subscription module 113 is invoked (e.g., preferably upon installation) and until it successfully subscribes, subscription module 113 may attempt to subscribe by communicating with publish module 103. After subscribing, subscription module 113 preferably polls publish module 103 from time to time. The polling process may determine whether the most recent executable files are stored on client system 102. If the executable files of client system 102 are not up to date, subscription module 113 preferably requests updated executable files.

Commercially available subscribe and publish algorithms may be utilized to implement embodiments of the present invention. For example, the company BackWeb markets a product called “BackWeb Foundation” to push content onto client systems. Specifically, “BackWeb Foundation” stores published content on hard drives of users systems without requiring any user interaction. “BackWeb Foundation” further updates the published content when new updates become available. This features has been utilized, for example, to deliver software patches to user systems.

It shall be appreciated that the present invention provides numerous advantages over “BackWeb Foundation.” Specifically, “BackWeb Foundation” essentially provides transport functionality, i.e. it provides a communication mechanism that is more efficient to deliver content than other Internet protocols. However, “BackWeb Foundation” is not related to interaction with the client system 102. The “BackWeb Foundation” is totally unconcerned with the content of the published material or how user systems utilize the published material. In contrast, embodiments of the present invention rely on the operations of the published material to obtain the desired metrics. Specifically, embodiments of the present invention provide collection executable 104A to facilitate interaction between client system 102 and server system 101 in a uniform and consistent manner.

When implemented via executable instructions, various elements of the present invention are in essence the code defining the operations of such various elements. The executable instructions or code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information that is accessible by the systems of the present invention.

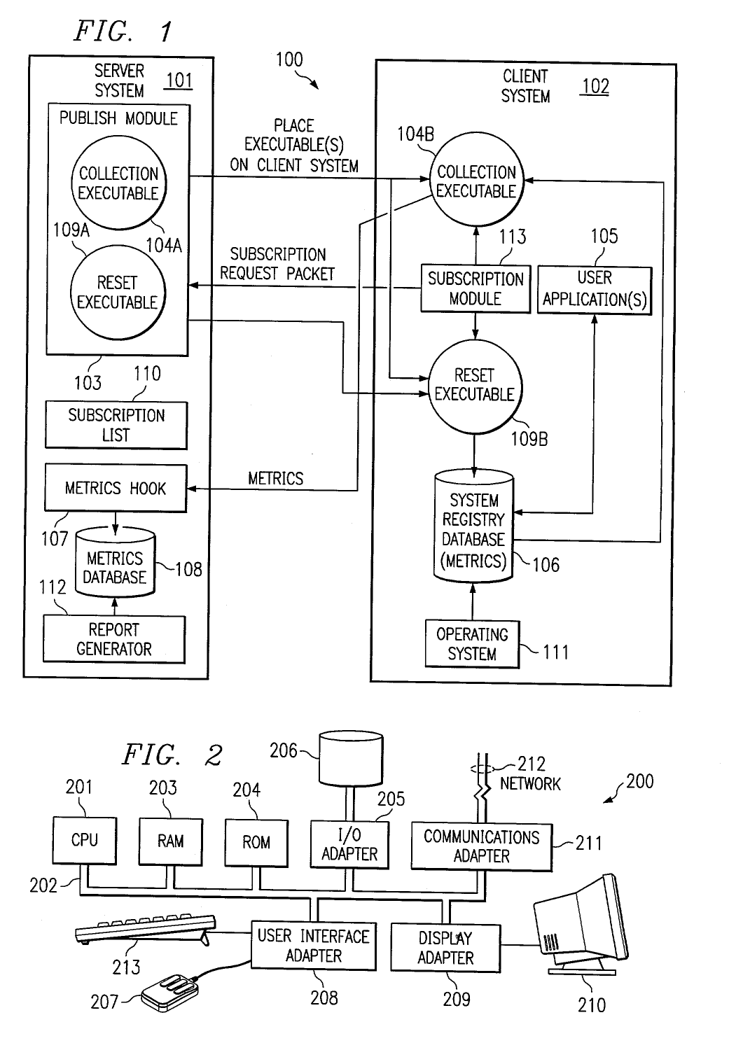

FIG. 2 illustrates computer system 200 that may be used to implement embodiments of the present invention. Specifically, computer system 200 may be utilized to implement either server system 101 or client system 102.

System 200 comprises central processing unit (CPU) 201 that is coupled to system bus 202. CPU 201 may be any general purpose CPU. Suitable processors, without limitation, include any processor from the ITANIUM family of processors or a PA-8500 processor available from Hewlett-Packard Company. However, the present invention is not restricted by the architecture of CPU 201 as long as CPU 201 supports the inventive operations as described herein.

CPU 201 operates under the control of executable instructions. If system 200 is used to implement server system 101, CPU 201 may operate under the control of the code or executable instructions that define publish module 103, metrics hook 107, report generator 112, and/or the like. If system 200 is used to implement client system 102, CPU 201 may operate under the control of the code or executable instructions that define collection executable 104B, user applications 105, reset executable 109B, operating system 111, and subscription module 113, and/or the like.

Computer system 200 may also include random access memory (RAM) 203, which may be SRAM, DRAM, SDRAM, or the like. Computer system 200 preferably includes ROM 204 which may be PROM, EPROM, EEPROM, or the like. RAM 203 and ROM 204 hold user and system data and programs as is well known in the art.

Computer system 200 also includes input/output (I/O) adapter 205, communications adapter 211, user interface adapter 208, and display adapter 209. I/O adapter 205 connects to storage devices 206, such as one or more of hard drive, CD drive, floppy disk drive, tape drive, to computer system 200. Storage devices 206 may be utilized to provide non-volatile storage capacity on a computer readable medium for various data elements and executable files, such as publish model 103, collection executables 104A and 104B, user applications 105, system registry database 106, metrics hook 107, metrics database 108, reset executable 109A and 109B, subscription list 110, reset executable 111, report generator 112, subscription module 113, and/or the like.

Communications adapter 211 is adapted to couple computer system 200 to a network 212, which may be one or more of telephone network, local area network (LAN), wide-area (WAN) network, Internet network, and/or the like. User interface adapter 208 couples user input devices, such as keyboard 213 and pointing device 207, to computer system 200. Display adapter 209 is driven by CPU 201 to control the display on display device 210.

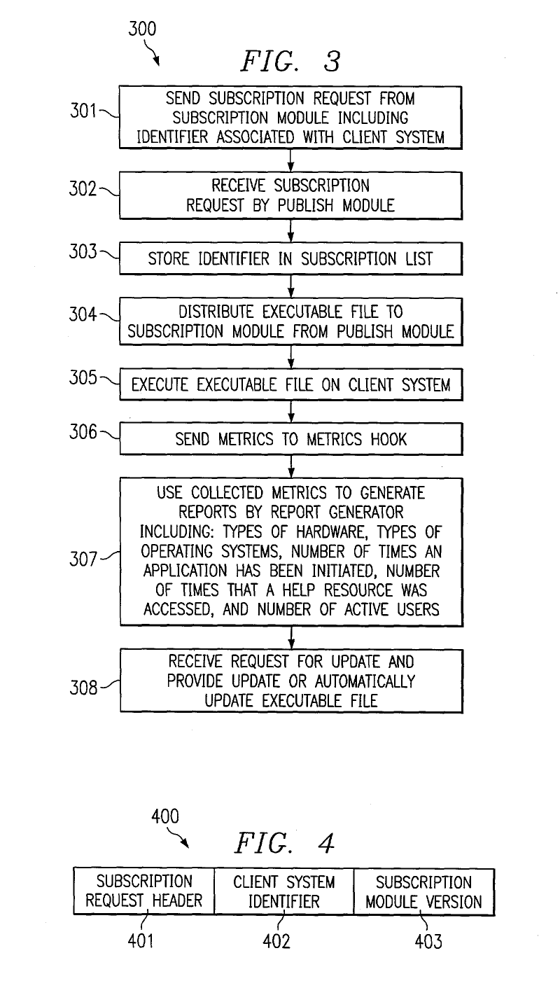

FIG. 3 depicts flowchart 300 associated with distribution and execution of a metrics gathering executable file according to embodiments of the present invention. In step 301, a subscription request is sent from subscription module 113 to publish module 103 including an identifier associated with client system 301. As shown in FIG. 4, subscription packet 400 may be utilized to implement the subscription request. Subscription packet 400 may include subscription request header 401 to identify the nature of the transaction that is being initiated. Subscription packet 400 may further include client system identifier 402 to enable identification of client system 100. Subscription packet 400 may include other suitable information such as subscription module version 403 to identify the version of code utilized to implement subscription module 113.

Returning now to flowchart 300 of FIG. 3, the subscription request is received by publish module 103 in step 302. The identifier is stored in subscription list 110 in step 303. In step 304, executable files 104A and 109A are distributed to subscription module 113 by publish module 103. Executable file 104B is executed on client system 100 (step 305). The metrics gathered by executable file 104B are sent to metrics hook 107 (step 306). In step 307, the collected metrics are used by report generator 112 to generate suitable reports. The reports may summarize the collected metrics by types of hardware, types of operating systems, number of times that an application has been executed, the number of times that a help resource was accessed, the number of active users, and/or the like.

In step 308, a request for an update of an executable file (e.g., collection executable 104A) may be received and the updated file may be sent from publish module 103 to subscription module 113. Alternatively, the updated executable file may be automatically distributed to subscription module 113. The request and/or distribution of the updated executable file need not occur immediately after collection and communication of metrics to server system 101. The request and/or distribution of the updated executable file may occur at any appropriate time.

Although embodiments of the present invention have been described as collecting metrics from a WINDOWS registry database, it shall be appreciated that these embodiments are examples. The present invention is not limited to any particular operating system. Specifically, embodiments of the present invention may be implemented on any suitable computer system that executes an operating system and/or user applications that produce collectable metrics.

1. A system for collecting metrics from at least one remote computer system, comprising:
a publish module that is operable to receive a subscription request from said at least one remote computer system and is operable to communicate an executable file to said at least one remote computer system, wherein said executable file is operable to collect said metrics from said at least one remote computer system when said executable file is executed on said at least one remote computer system; and
a metrics receiving process that is operable to receive collected metrics from said at least one remote computer system when said at least one remote computer system executes said executable file.

2. The system of claim 1 further comprising:
a database for storing said received metrics.

3. The system of claim 2 wherein said metrics receiving process is operable to parse said received metrics before said metrics are stored in said database.

4. The system of claim 1 further comprising:
a subscription list, wherein said publish module stores an identifier associated with said at least one remote computer system in said subscription list.

5. The system of claim 1 further comprising:
a report generator that is operable to summarize received metrics by at least one item selected from the group consisting of types of hardware, types of operating systems, number of times that an application has been initiated, number of times that a help resources was accessed, and number of active users.

6. The system of claim 1 wherein said executable file is operable to retrieve metrics from a registry database when said executable file is executed on said at least one remote computer system.

7. The system of claim 1 wherein said publish module is further operable to receive requests from said at least one remote computer system to obtain updates of said executable file.

8. The system of claim 1 wherein said publish module is further operable to automatically communicate an updated version of said executable file to said at least one computer system.

9. A computer readable medium comprising executable instructions for collecting metrics, said computer readable medium comprising:
code for receiving a subscription request from a remote computer system;
code for communicating an executable file to said remote computer system in response to said subscription request, wherein said executable file is operable to collect said metrics from said remote computer system when said executable file is executed on said remote computer system; and
code for receiving collected metrics from said remote computer system, when said executable file is executed on said remote computer system.

10. The computer readable medium of claim 9 wherein said code for receiving is operable to parse said received metrics.

11. The computer readable medium of claim 9 further comprising:
code for storing received metrics in a database.

12. The computer readable medium of claim 9 wherein said code for receiving a subscription request is operable to store an identifier associated with said remote computer system in a subscription list.

13. The computer readable medium of claim 9 further comprising:
code for generating a report that summarizes received metrics by at least one item selected from the group consisting of types of hardware, types of operating systems, number of times that an application has been initiated, number of times that a help resources was accessed, and number of active users.

14. The computer readable medium of claim 9 wherein said executable file is operable to collect metrics from a registry database when said executable file is executed on said remote computer system.

15. The computer readable medium of claim 9 further comprising:
code for communicating an updated version of said executable file to said remote computer system.

16. The computer readable medium of claim 15 wherein said code for communicating an updated version automatically communicates said updated version.

17. The computer readable medium of claim 15 wherein said code for communicating an updated version communicates said updated version in response to a request from said remote computer system.

18. A method for collecting metrics from a remote computer system, wherein said method is implemented as executable instructions on a server computer system, said method comprising:
receiving a subscription request from said remote computer system;
communicating an executable file to said remote computer system, wherein said executable file is operable to collect said metrics from said remote computer system when said executable file is executed on said remote computer system; and
receiving collected metrics from said remote computer system when said executable file is executed on said remote computer system.

19. The method of claim 18, wherein an updated version of said executable file is stored on said server computer system, said method further comprising:
communicating said updated version to said remote computer system.

20. The method of claim 19 wherein said communicating said update version occurs in response to a request from said remote computer system to receive said updated version.
